(19) United States
(12) Patent Application Publication
(10) Pub. No.: US 2017/0233167 A1
(43) Pub. Date: Aug. 17, 2017

(54) Wine Preserving and Storing Device

(71) Applicant: Azhar Rauf, Houston, TX (US)

(72) Inventor: Azhar Rauf, Houston, TX (US)

(21) Appl. No.: 15/405,493

(22) Filed: Jan. 13, 2017

Related U.S. Application Data
(60) Provisional application No. 62/278,442, filed on Jan. 14, 2016.

(51) Int. Cl. B65D 83/00; B67D 1/08; B67D 1/00

(52) U.S. Cl. CPC B65D 83/0022; B67D 1/0004; B67D 1/0891

(57) ABSTRACT

A preserving device for preserving a liquid fluid may include a container for storing the liquid fluid; a piston to engage the interior surface of the container and to move within the container to compress the liquid fluid; and a replaceable lid for the container to allow the liquid fluid to enter the container and to allow the liquid fluid to escape the container as the piston is moved within the container

### FIELD OF THE INVENTION

The present invention relates to wine bottling and more particularly to wine bottling and preserving.

### BACKGROUND

When a bottle of wine or similar liquid is opened, air enters the bottle and the process of oxidation of the wine begins. Any wine that is not consumed within a short period of time is ruined as a result of the oxidation. Some external devices to the bottle like a pump or balloon helps to keep the air out of the bottle. However, these types of devices merely slow the process of oxidation and does not completely stop the oxidation.

### SUMMARY

A preserving device for preserving a liquid fluid may include a container for storing the liquid fluid; a piston to engage the interior surface of the container and to move within the container to compress the liquid fluid; and a replaceable lid for the container to allow the liquid fluid to enter the container and to allow the liquid fluid to escape the container as the piston is moved within the container.

The liquid fluid may be wine.

The replaceable lid may be threadably connected to the container.

The container may be connected to a base to mount on a support surface.

The base may be connected to a stem which is connected to the piston.

The stem may be threadably connected to the piston.

The stem may be threadably connected to the base.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the wine preserving device of the present invention;

FIG. 2 illustrates a cross-sectional view of the container of the wine preserving device of the present invention;

FIG. 3 illustrates a perspective view of the stem of the wine preserving device of the present invention;

FIG. 4 illustrates a cross-sectional view of the base of the wine preserving device of the present invention;

FIG. 5 illustrates a cross-sectional view of the piston, stem and base of the wine preserving device of the present invention;

FIG. 6 illustrates a cross-sectional view of a spout of the wine preserving device of the present invention;

FIG. 7 illustrates a cross-sectional view of a lid of the wine preserving device of the present invention;

FIG. 8 illustrates a cross-sectional view of the piston of the wine preserving device of the present invention;

FIG. 9 illustrates a cross-sectional view of another embodiment of the wine preserving device of the present invention in a first position;

FIG. 10 illustrates a cross-sectional view of another embodiment of the wine preserving device of the present invention in a second position;

FIG. 11 illustrates an exploded view of a portion of the wine preserving device of the present invention;

FIG. 12 illustrates an exploded view of another portion of the wine preserving device of the present invention;

FIG. 13 illustrates an exploded view of a portion of the wine preserving device of the present invention;

FIG. 14 illustrates an exploded view of another portion of the wine preserving device of the present invention;

FIG. 15 illustrates a perspective view of the wine preserving device of the present invention;

FIG. 16 illustrates a perspective view of another embodiment of the wine preserving device of the present invention;

FIG. 17 illustrates an exploded view of the wine preserving device of the present invention;

FIG. 18 illustrates a perspective view of the wine preserving device of the present invention.

### DETAILED DESCRIPTION

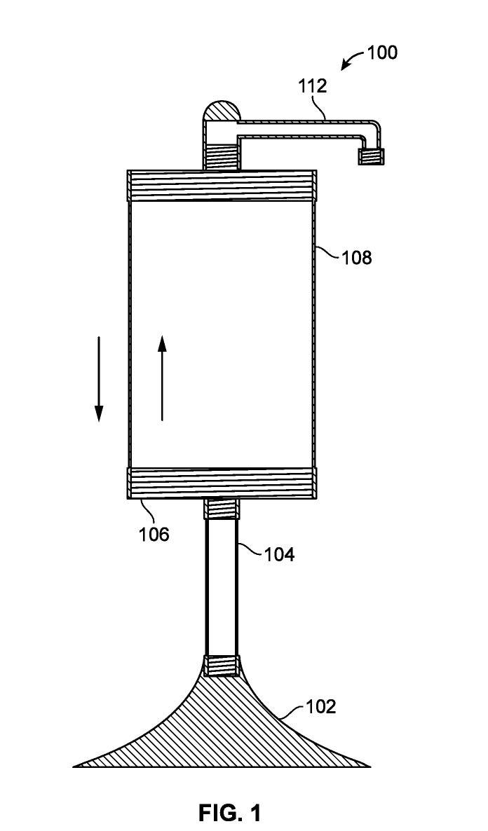

FIG. 1 illustrates a cross-sectional view of the wine preserving device 100 of the present invention which may include a base 102 which may connect with a support surface (not shown), which may be a truncated conical shape, or other appropriate shape and which may be threadably connected to a stem 104. The base 102 may be hollow or solid and may be formed from metal, plastic, wood or other appropriate material. The stem 104 may be a longitudinal rod being threadably connected to the base 102 and threadably connected to the piston 106. The stem 104 may be sufficiently long so that the piston 106 may extend from the bottom of the container 108 to the top of the container 108 so that no oxygen may be present within the container 108 to oxidize the wine or other fluid. The stem 104 may be hollow or solid and may be formed from metal, plastic, wood or other appropriate material.

The piston 106 may include a disk shaped portion which may frictionally cooperate with the interior walls of the container 108 and the piston 106 may seal the container 108 to prevent the fluid which may be wine from flowing beyond the piston 106. The piston 106 may be hollow or solid and may be formed from metal, plastic, wood or other appropriate material.

The container 108 may be cylinder shaped and may be opened on both ends and may cooperate with the piston 106 and may cooperate with a lid 110. Both the lid 110 and the container 108 may be threadably connected and provide a seal to retain the wine within the container 108.

The lid 110 may include a central aperture 114 which may be in fluid communication with a valve 112 to drain the fluid which may be wine from the container 108 to the valve 112 and through the mouth of the valve 112. The valve 112 may be threadably connected to the lid 110. The lid 110 and valve 112 may be hollow or solid and may be formed from metal, plastic, wood or other appropriate material.

In operation, fluid such as wine may be combined with air and placed into the container 108, and the piston 106 may advance into the container 108. Since the air will above the fluid which may be wine, the air is pushed out through the valve 112. The piston 106 advances until all the air has been removed from the container 108 leaving the container 108 free from air.

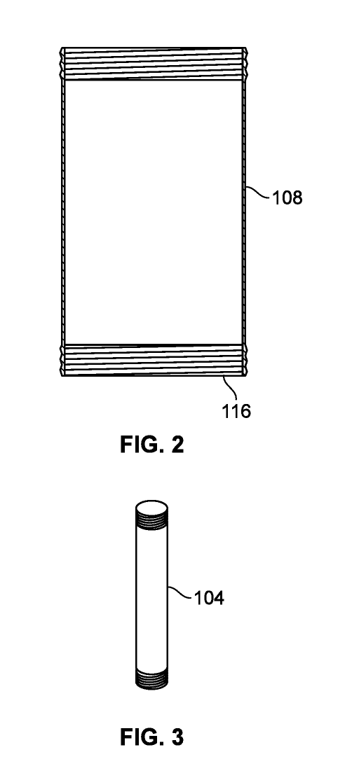

FIG. 2 illustrates the container 108 which may be shaped as a cylinder having each end open to a container central aperture 116 which may extend the entire length of the container 108. The container 108 may include threads at one end to engage the lid 110.

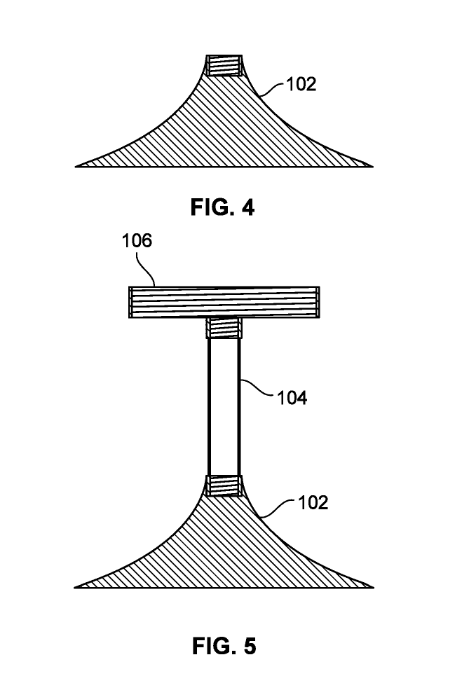

FIG. 3 illustrates the stem 104 having threads on each end to connect to the base 102 and the piston 106.

FIG. 4 illustrates the conical base 102 having threads to engage the threads of the stem 104.

FIG. 5 illustrates conical base 102 connected to the stem 104 which may be connected to the piston 106.

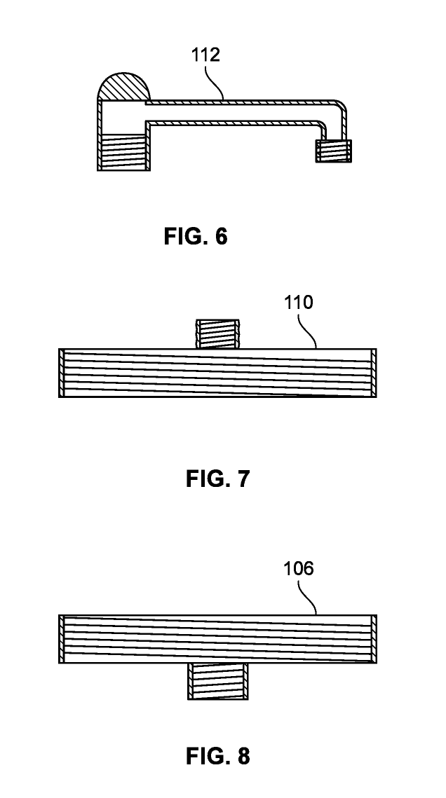

FIG. 6 illustrates the valve 112 which may connect to the lid 110.

FIG. 7 illustrates the lid 110.

FIG. 8 illustrates the piston 106.

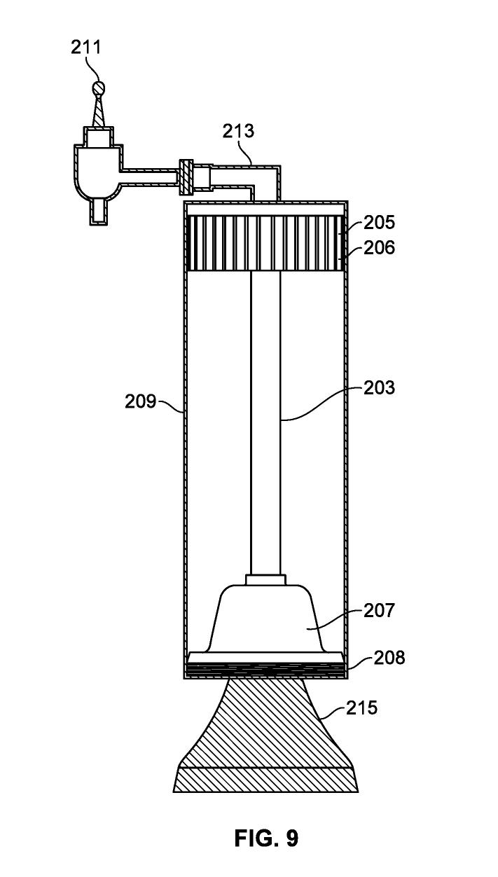

FIG. 9 illustrates another embodiment of the wine preserving device 200 which may include a container 209 which may be in the shape of a cylinder or other appropriate shape and which may store fluid such as wine to be preserved. A central shaft 203 which may be solid or hollow may extend through the container 209 to facilitate the movement of the piston 205 which may be a cylinder shape and which may include a seal 206 to form a friction fit with the interior surface of the container 209, allowing the piston 205 to move the fluid such as wine. The bottom of the container 209 may engage a base 207 to seal the container with a seal 208. The shaft 203 may extend through the base 207 to allow the base to travel along the shaft 203. FIG. 9 shows that the piston 205 is substantially at the top of the container 209 pushing substantially all of the fluid such as wine into the passageway 213 and through the valve 211. The shaft 203 may be connected to the support base 215.

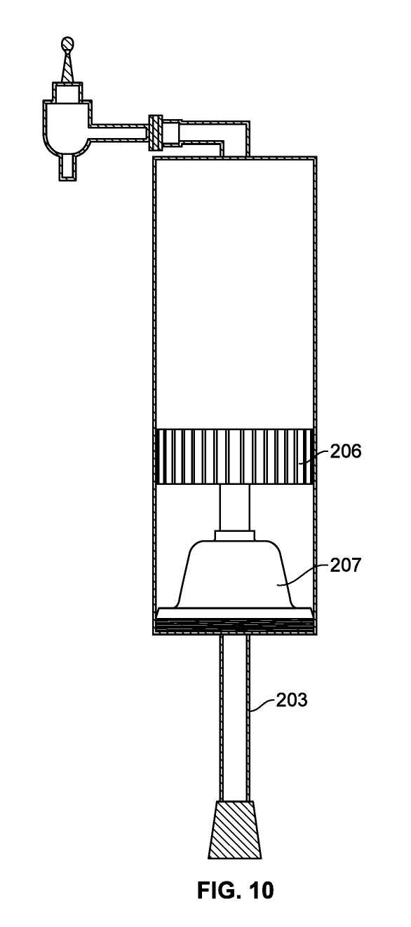

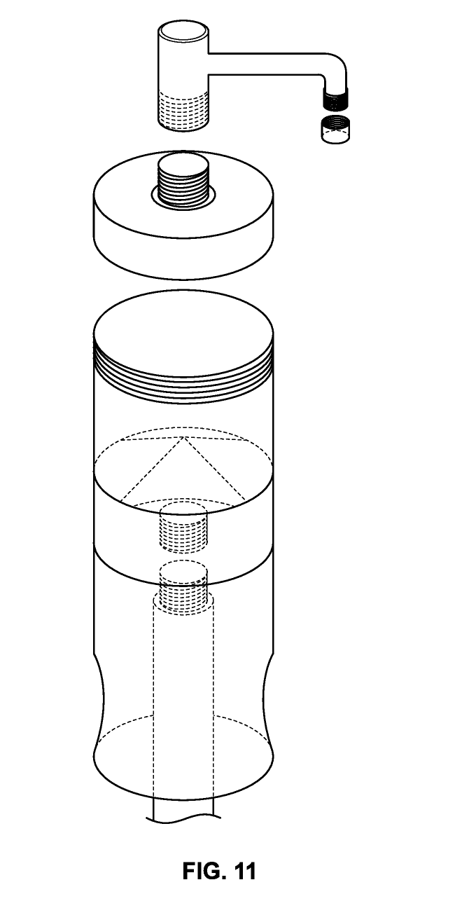

FIG. 10 illustrates the piston 205 being at a lower position allowing the portion of the container 209 above the piston 205 to be filled with the fluid such as wine. Furthermore, the base 207 has moved along the shaft 203.

FIG. 11 illustrates an exploded view of a portion of the wine preserving device of the present invention.

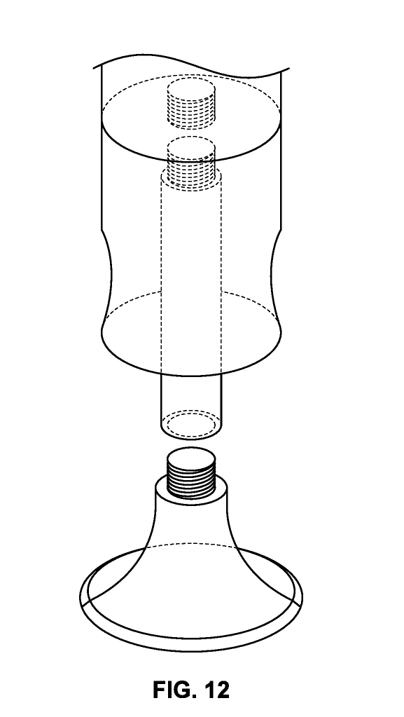

FIG. 12 illustrates an exploded view of another portion of the wine preserving device of the present invention.

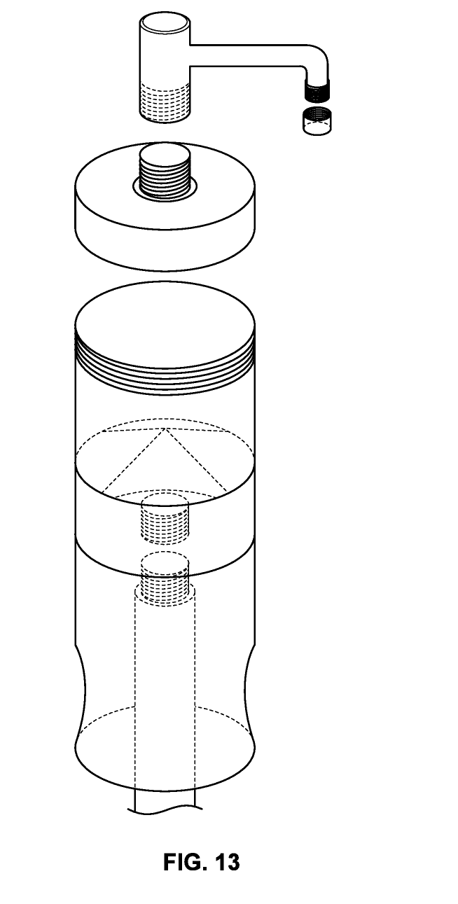

FIG. 13 illustrates an exploded view of a portion of the wine preserving device of the present invention.

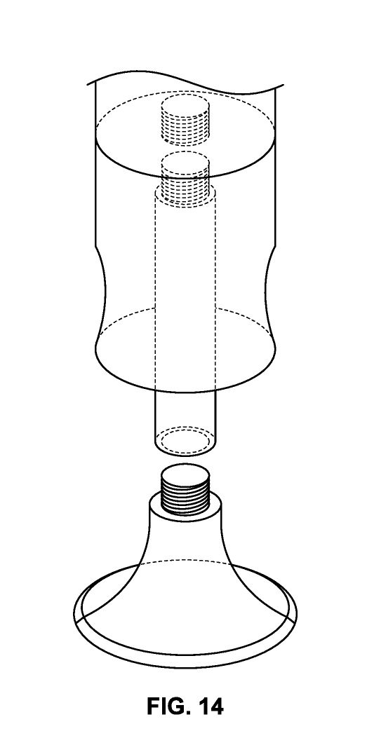

FIG. 14 illustrates an exploded view of another portion of the wine preserving device of the present invention.

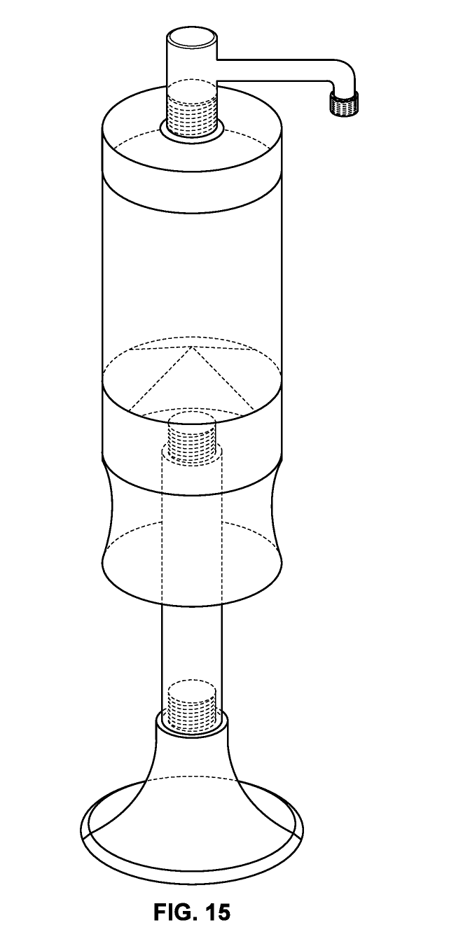

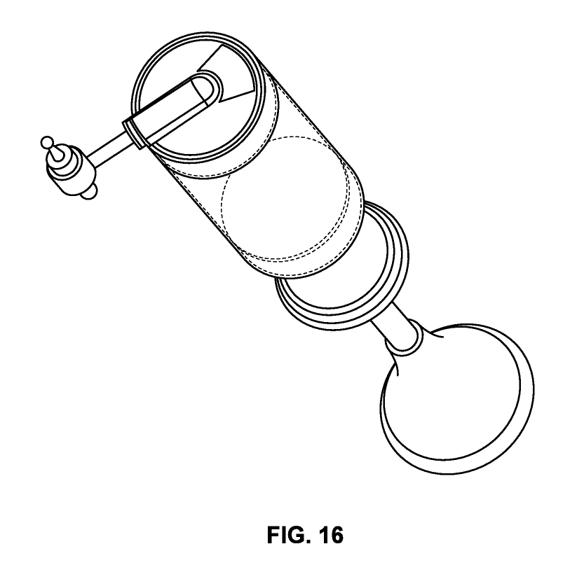

FIG. 15 illustrates a perspective view of the wine preserving device of the present invention.

FIG. 16 illustrates a perspective view of another embodiment of the wine preserving device of the present invention.

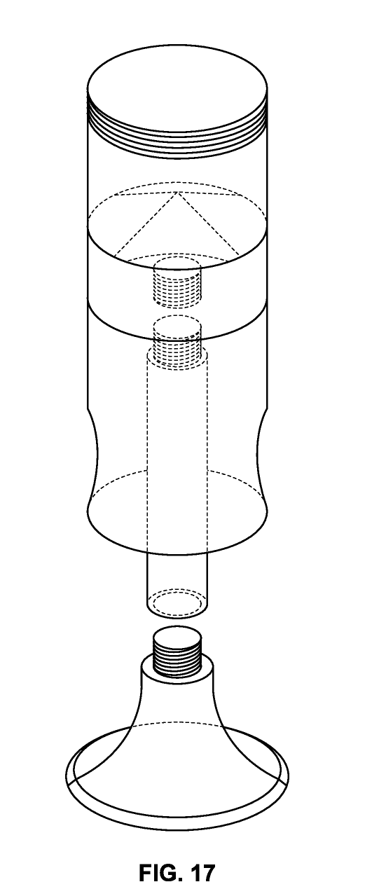

FIG. 17 illustrates an exploded view of the wine preserving device of the present invention.

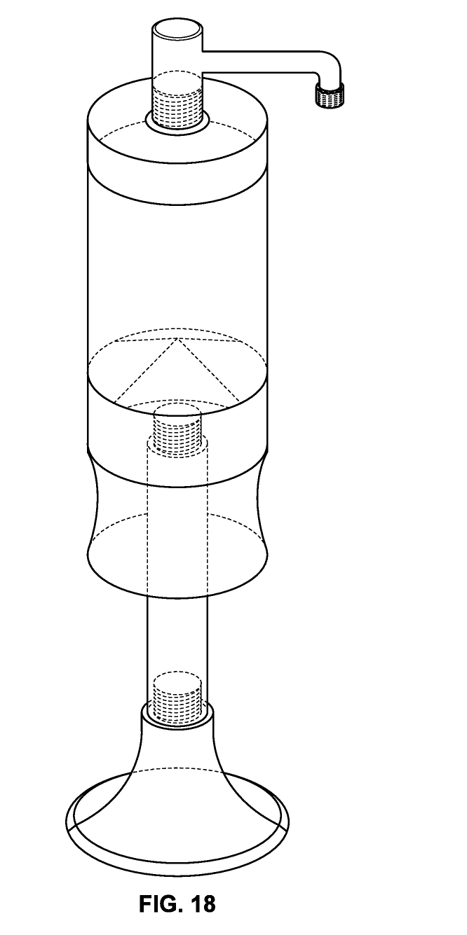

FIG. 18 illustrates a perspective view of the wine preserving device of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A preserving device for preserving a liquid fluid, comprising:
a container for storing the liquid fluid;
a piston to engage the interior surface of the container and to move within the container to compress the liquid fluid;
a replaceable lid for the container to allow the liquid fluid to enter the container and to allow the liquid fluid to escape the container as the piston is moved within the container.

2. A preserving device for preserving a liquid fluid as in claim 1, wherein the liquid fluid is wine.

3. A preserving device for preserving a liquid fluid as in claim 1, wherein the replaceable lid is threadably connected to the container.

4. A preserving device for preserving a liquid fluid as in claim 1, wherein the container is connected to a base to mount on a support surface.

5. A preserving device for preserving a liquid fluid as in claim 4, wherein the base is connected to a stem which is connected to the piston.

6. A preserving device for preserving a liquid fluid as in claim 5, wherein the stem is threadably connected to the piston.

7. A preserving device for preserving a liquid fluid as in claim 5, wherein the stem is threadably connected to the base.
